(19) United States
(12) Patent Application Publication
(10) Pub. No.: US 2024/0275089 A1
(43) Pub. Date: Aug. 15, 2024

(54) HIGH DENSITY, HIGH SPEED, HIGH PERFORMANCE CARD EDGE CONNECTOR

(71) Applicant: Amphenol Commercial Products (Chengdu) Co., Ltd., Chengdu (CN)

(72) Inventors: Kui Yang, Chengdu (CN); Xiaodong Hu, Chengdu (CN)

(73) Assignee: Amphenol Commercial Products (Chengdu) Co., Ltd., Chengdu (CN)

(21) Appl. No.: 18/436,308

(22) Filed: Feb. 8, 2024

(30) Foreign Application Priority Data
Feb. 9, 2023 (CN) 202320208350.1

(51) Int. Cl. H01R 12/71; H01R 12/73; H01R 13/24; H01R 13/502

(52) U.S. Cl. CPC H01R 12/716; H01R 12/737; H01R 13/2464; H01R 13/502

(57) ABSTRACT

A connector for high density, high speed, and high performance electronic systems. The connector has terminals held in a housing. Each terminal has a mating end, a mounting end, and an intermediate portion inbetween. A pair of cuts are disposed on opposite sides of the mounting end such that the mounting end is narrower than the intermediate portion. Each mounting end has a flat surface configured for a solder ball to be attached thereto and narrower than a diameter of the solder ball. This enables the solder ball to be reliably mounted to a contact pad on a circuit board that sized smaller than the solder ball. The contact pad can have a round shape such that a conductive trace can extend in any direction therefrom, which provides flexible routing. Such a configuration meets signal integrity requirements in connectors designed for 64 Gbps and beyond, while conforming to a standard that constrains mating and mounting interfaces.

### CROSS-REFERENCE TO RELATED APPLICATIONS

This application claims priority to and the benefit of Chinese Patent Application Serial No. 202320208350.1, filed Feb. 9, 2023, the contents of which are incorporated herein by reference in their entirety.

### TECHNICAL FIELD

This application relates generally to electrical interconnection systems, such as those including electrical connectors, used to interconnect electronic assemblies.

### BACKGROUND

Electrical connectors are used in many electronic systems. It is easier and more cost effective to manufacture a system as separate electronic assemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

Computers, for example, are often manufactured with connectors that serve as sockets for memory cards. A memory card may contain one or multiple memory chips and may be inserted into a socket to increase the available memory in the computer. Memory cards have standardized electrical and mechanical interfaces, so as do the memory sockets. Many memory cards, for example, are designed according to a DDR standard, such as DDR4 or DDR5.

### BRIEF SUMMARY

Aspects of the present disclosure relate to high density, high speed, and high performance card edge connectors.

Some embodiments relate to an electrical connector. The electrical connector may include a housing comprising a slot; a plurality of terminals held by the housing, each of the plurality of terminals comprising a mating end having a mating contact portion curving into the slot, a mounting end opposite the mating end, and an intermediate portion joining the mating end and the mounting end; and a plurality of solder balls, each of the plurality of solder balls attached to the mounting end of a respective terminal of the plurality of terminals. The mounting end of each of the plurality of terminals may be narrower than the respective intermediate portion and disposed such that the respective intermediate portion extends beyond opposite sides of the mounting end. The mounting end of each of the plurality of terminals may comprise a flat surface. Each of the plurality of solder balls may be attached to the flat surface of the mounting end of a respective terminal of the plurality of terminals. The flat surface of the mounting end of each of the plurality of terminals may be narrower than the respective solder ball attached thereto.

Optionally, the mounting end of each of the plurality of terminals is disposed in a central portion of the respective intermediate portion; and each of the plurality of terminals comprises a pair of cuts disposed on the opposite sides of the respective mounting end.

Optionally, the slot of the housing is configured for receiving a DDR card.

Optionally, the mounting end of each of the plurality of terminals comprises a portion extending perpendicular to a mating direction; and the portion comprises the flat surface attached with the solder ball.

Optionally, the slot of the housing extends in a longitudinal direction perpendicular to the mating direction; the portion of the mounting end of each of the plurality of terminals has a length in a transverse direction perpendicular to the mating direction and the longitudinal direction; and the length of the portion of the mounting end of each of the plurality of terminals is sized such that the portion is positioned between planes in which opposite sides of the housing extend.

Optionally, the plurality of terminals are a plurality of first terminals arranged in a first row; the electrical connector comprises a plurality of second terminals arranged in a second row parallel to the first row; and each of the plurality of second terminals comprises a mating end having a mating contact portion curving into the slot and toward the mating contact portion of a respective first terminal of the plurality of first terminals, and a mounting end extending out of the housing and away from the mounting end of the respective first terminal of the plurality of first terminals.

Optionally, the mounting end of each of the plurality of second terminals comprises a portion extending in the transverse direction; the portion of the mounting end of each of the plurality of second terminals has a length in the transverse direction; and the length of the portion of the mounting end of each of the plurality of second terminals is sized such that the portion is positioned between the planes in which the opposite sides of the housing extend.

Some embodiments relate to an electrical connector. The electrical connector may include a housing comprising a slot; a plurality of terminals held by the housing, each of the plurality of terminals comprising: a mating end having a mating contact portion curving into the slot, a mounting end opposite the maing end, and an intermediate portion joining the mating end and the mounting end, the intermediate portion being wider than the mounting end; and an organizer attached to the housing, the organizer comprising a plurality of first recesses facing toward the housing, a plurality of second recesses facing away from the housing, and a plurality of openings connecting respective first recesses and second recesses to each other. The mounting end of each of the plurality of terminals extends from a respective first recess through a respective opening to a respective second recess. The mounting end of each of the plurality of terminals comprises a flat surface extending in a plane perpendicular to a mating direction and disposed inside a respective second recess.

Optionally, the organizer comprises a plurality of projections; and a respective opening of the plurality of openings is surrounded by respective projections of the plurality of projections.

Optionally, each of the plurality of projections comprises slanted surfaces bounding a respective first recess.

Optionally, the slot of the housing extends in a longitudinal direction; each of the plurality of first recesses has a first width the longitudinal direction; each of the plurality of second recesses has a second width in the longitudinal direction; and the second width is greater than the first width.

Optionally, the organizer comprises a base portion extending in another plane perpendicular to the mating direction and a plurality of protrusions extending perpendicular to the base portion and toward the housing; and each of the plurality of protrusions comprises a projection disposed in a matching recess of the housing.

Optionally, the housing comprises separators disposed between adjacent matching recesses so as to restrain movements of the plurality of protrusions in the longitudinal direction and/or a transverse direction perpendicular to both the longitudinal direction and the mating direction.

Optionally, the organizer comprises ceramic.

Optionally, the electrical connector may include a plurality of solder balls attached to the flat surfaces of the mounting ends of respective terminals of the plurality of terminals, wherein each of the plurality of solder balls is at least partially disposed in a respective second recess of the plurality of second recesses of the organizer.

Optionally, the slot of the housing extends in a longitudinal direction; and the flat surface of the mounting end of each of the plurality of terminals is narrower than a respective solder ball of the plurality of solder balls in the longitudinal direction.

Some embodiments relate to an electronic system. The electronic system may include a printed circuit board comprising a surface having a plurality of contact pads; and an electrical connector comprising: a housing comprising a slot, and a plurality of terminals held by the housing in a row in a longitudinal direction, each of the plurality of terminals comprising a mating end having a mating contact portion curving into the slot and a mounting end opposite the mating end; and a plurality of solder balls electrically coupling the plurality of terminals of the electrical connector to the plurality of contact pads of the printed circuit board. The plurality of solder balls may be wider than respective contact pads in the longitudinal direction. The mounting ends of the plurality of terminals may be narrower respective contact pads in the longitudinal direction.

Optionally, the printed circuit board comprises a trace extending from a contact pad of the plurality of contact pads; and the trace is elongated in a direction extending in a non-right angle to the longitudinal direction.

Optionally, the plurality of contact pads are circular contact pads.

Optionally, the mounting end of each of the plurality of terminals comprises a flat surface attached with a respective solder ball of the plurality of solder balls; and each of the plurality of terminals comprises a pair of cuts disposed on opposite sides of a respective mounting end.

Some embodiments relate to a card edge connector. The card edge connector may comprise a housing, a plurality of terminals and a plurality of solder balls, the housing may comprise a slot extending in a longitudinal direction perpendicular to a mating direction, the plurality of terminals may be held by the housing, each of the plurality of terminals may comprise a mating end having a mating contact portion, a mounting end and an intermediate portion, the mating contact portion may curve into the slot, the mounting end may extend out of the housing, the intermediate portion may join the mating end and the mounting end, each of the plurality of solder balls may be attached to the mounting end of a respective terminal of the plurality of terminals, wherein the mounting end of each of the plurality of terminals may be narrower than the respective intermediate portion in the longitudinal direction and may be disposed such that the respective intermediate portion extends in the longitudinal direction beyond opposite sides of the mounting end. The mounting end of each of the plurality of terminals may comprise a flat surface, each of the plurality of solder balls may be attached to the flat surface of the mounting end of a respective terminal of the plurality of terminals, the flat surface of the mounting end of each of the plurality of terminals may have a width in the longitudinal direction less than a diameter of the respective solder ball attached to the mounting end.

Optionally, the mounting end of each of the plurality of terminals may be disposed in a central portion of the respective intermediate portion.

Optionally, each of the plurality of terminals may comprise a pair of cuts that may be disposed on the opposite sides of the respective mounting end.

Optionally, the mounting end of each of the plurality of terminals may comprise a portion extending in a transverse direction perpendicular to the mating direction and the longitudinal direction, the portion may comprise the flat surface attached with the solder ball.

Optionally, the portion of the mounting end may have a dimension in the transverse direction which is sized such that the portion is positioned between sides of the housing.

Optionally, the housing may comprise a mating face and a mounting face, a plurality of openings are arranged respectively on the two side surfaces of the slot extending in the longitudinal direction, the housing may further comprise a plurality of channels, each of the plurality of channels is extended from the mounting face of the house through the housing and is in communication with the slot via a respective opening of the plurality of openings.

Optionally, the plurality of terminals may be a plurality of first terminals arranged in a first row, the card edge connector may comprise a plurality of second terminals arranged in a second row parallel to the first row, and each of the second plurality of terminals may comprise a mating end having a mating contact portion and a mounting end, the mating contact portion of the second terminal may curve into the slot and toward the mating contact portion of a respective first terminal of the first plurality of terminals, the mounting end of the second terminal may extend out of the housing and away from the mounting end of the respective first terminal of the plurality of first terminals.

Optionally, the plurality of first terminals in the first row and the plurality of second terminals in the second row may be disposed in the longitudinal direction of the housing, each of the first and second terminals may be shaped as an elongated rib-shaped plate.

Optionally, the mounting end of each of the plurality of second terminals may comprise a portion extending in the transverse direction, the portion of the mounting end of the second terminal may have a dimension in the transverse direction which is sized such that the portion is positioned between the sides of the housing.

Some embodiments relate to a card edge connector. The card edge connector may comprise a housing, a plurality of terminals and an organizer, the housing may comprise a slot extending in a longitudinal direction perpendicular to a mating direction, the plurality of terminals may be held by the housing, each of the plurality of terminals may comprise a mating end having a mating contact portion, a mounting end and an intermediate portion, the mating contact portion may curve into the slot, the mounting end may extend out of the housing, the intermediate portion may join the mating end and the mounting end, the organizer may be attached to the housing, the organizer may comprise a plurality of first recesses, a plurality of second recesses and a plurality of openings, the plurality of first recesses may face towards the housing, the plurality of second recesses may face away from the housing, the plurality of openings may connect respective first recess and second recess to each other, wherein the mounting end of each of the plurality of terminals may be narrower than the respective intermediate portion in the longitudinal direction and may be disposed such that the respective intermediate portion may extend in the longitudinal direction beyond opposite sides of the mounting end, the mounting end of each of the plurality of terminals may extend from a respective first recess through a respective opening to a respective second recess, and the mounting end of each of the plurality of terminals may comprise a flat surface that may extend in a plane perpendicular to the mating direction and be disposed inside a respective second recess, the flat surface of the mounting end of each of the plurality of terminals may be attached with the solder balls, the flat surface of the mounting end of each of the plurality of terminals may have a width in the longitudinal direction less than a diameter of the respective solder ball attached to the mounting end.

Optionally, the organizer may comprise a plurality of projections, and a respective opening of the plurality of openings is surrounded by respective projection of the plurality of projections.

Optionally, each of the plurality of projections may comprise slanted surfaces bounding a respective first recess.

Optionally, each of the plurality of first recesses may have a first width in the longitudinal direction, each of the plurality of second recesses may have a second width in the longitudinal direction, the second width may be greater than the first width.

Optionally, the organizer may comprise a base portion extending in another plane perpendicular to the mating direction and a plurality of protrusions extending perpendicular to the base portion and toward the housing, and each of the plurality of protrusions may comprise a projection disposed in a matching recess of the housing.

Optionally, the housing may comprise separators disposed between adjacent matching recesses so as to restrain movements of the plurality of protrusions in the longitudinal direction.

Optionally, the organizer may comprise ceramic.

Optionally, a plurality of solder balls may be electrically coupled to the plurality of terminals, wherein each of the plurality of solder balls is at least partially disposed in a respective second recess of the plurality of second recesses of the organizer.

Some embodiments relate to an electronic system. The electronic system may comprise a printed circuit board and a card edge connector, the printed circuit board may comprise a surface having a plurality of circular contact pads, the card edge connector may comprise a housing, a plurality of terminals and a plurality of solder balls, the housing may comprise a slot extending in a longitudinal direction perpendicular to a mating direction, the plurality of terminals may be held by the housing, and each of the plurality of terminals may comprise a mating contact portion that may curve into the slot and a mounting end which may extend out of the housing, each of the plurality of solder balls may electrically couple the plurality of terminals of the card edge connector to the respective one of the plurality of circular contact pads of the printed circuit board, wherein the solder ball may have a diameter greater than a diameter of a respective circular contact pad, and the diameter of the respective circular contact pad may be greater than the width of the mounting end of a respective terminal in the longitudinal direction.

Optionally, the printed circuit board may comprise a trace extending from the plurality of circular contact pads, and the trace may be extended in a direction extending in an angle to the longitudinal direction.

Optionally, the plurality of circular contact pads may be aligned in the longitudinal direction.

Optionally, the mounting end of each of the plurality of terminals may comprise a flat surface attached with a respective solder ball of the plurality of solder balls.

Optionally, each of the plurality of terminals may comprise a pair of cuts that can be disposed on opposite sides of a respective mounting end.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, side perspective view of an electronic system, according to some embodiments.

FIG. 2 is a top, side perspective view of a printed circuit board of the electronic system of FIG. 1.

FIG. 3A is a top, side perspective view of a card edge connector of the electronic system of FIG. 1.

FIG. 3B is a partial cross-sectional perspective view of the card edge connector of FIG. 3A, taken in a transverse direction.

FIG. 3C is a bottom, side perspective view of the card edge connector of FIG. 3A.

FIG. 3D is a partial cross-sectional perspective view of the card edge connector of FIG. 3C, taken in the transverse direction.

FIG. 4A is a perspective view of terminals of the card edge connector of FIG. 3A, illustrating two terminals with solder balls attached thereon.

FIG. 4B is a bottom view of the terminals of FIG. 4A.

FIG. 4C is a side view of a mounting end of one of the terminals of FIG. 4A.

FIG. 5 is a partial cross-sectional perspective view of the electronic system of FIG. 1, taken in a transverse direction.

FIG. 6 is a top, side perspective view of an electronic system, according to some embodiments.

FIG. 7A is a perspective view of terminals in a card edge connector of the electronic system of FIG. 6, illustrating two terminals with solder balls attached thereon.

FIG. 7B is a bottom view of the terminals of FIG. 7A.

FIG. 7C is a side view of a mounting end of one of the terminals of FIG. 7A.

FIG. 8A is a cross-sectional perspective view of the electronic system of FIG. 6, taken in the transverse direction.

FIG. 8B is a partial perspective view of the electronic system of FIG. 6, illustrating relationships between the sizes of the solder balls, contact pads and terminals.

FIG. 9 is a perspective view of an electronic system, according to some embodiments.

FIG. 10 is a partially exploded perspective view of the electronic system of FIG. 9, according to some embodiments.

FIG. 11 is a partially exploded perspective view of the electronic system of FIG. 9, according to some embodiments.

FIG. 12A is a top, side perspective view of an organizer of the card edge connector of FIG. 11.

FIG. 12B is a bottom, side perspective view of the organizer of FIG. 12A.

FIG. 12C and FIG. 12D are schematic illustrations of a first recess and a second recess of the organizer of FIG. 12A.

FIG. 12E is a cross-sectional perspective view of FIG. 12A, taken in the transverse direction.

FIG. 13 is a cross-sectional perspective view of the electronic system of FIG. 11, taken in the transverse direction.

FIG. 14 is a schematic illustration of pads and a routing direction for a pad of a conventional connector with surface mount terminals.

FIG. 15 is a schematic illustration of pads and routing directions for a pad of a connector according to some embodiments of the present application.

### DETAILED DESCRIPTION

The inventors have recognized and appreciated connector design techniques for high density, high speed, and high performance electronic systems. Increasing transmission rate poses significant challenges for maintaining and/or improving the integrity of the signals passing through a connector. The inventors have recognized and appreciated designs for a mounting interface between a connector and a circuit board that can improve signal integrity when dense signals are transmitted at high speed. The techniques described herein may enable narrower terminals being soldered to bigger contact pads, which can better match the impedance of the connector to a memory card inserted in a slot of the connector (and/or the circuit board to which the connector is mounted). Better impedance match can enable the connector to operate at higher speeds and/or with leass signal distortion and therefore improve signal integrity. Further, having circular contact pads on the printed circuit board can provide more flexibility for routing from the pads. A connector satisfying the mechanical requirements of the DDR specification at the performance required for DDR5 and beyond is used as an example of a connector in which these techniques have been applied.

A card edge connector may include a housing having a slot elongating in a longitudinal direction. The slot may be configured for receiving an electronic card such as a memory card, which may be inserted into the slot in a mating direction perpendicular to the longitudinal direction. The housing may have channels extending from a mating face to a mounting face. The channels may have openings to the slot.

The connector may have terminals held in the channels. Each terminal may have a mating end having a mating contact portion curving into the slot through the opening of a respective channel, a mounting end extending out of the mounting face of the housing, and an intermediate portion joining the mating contact portion and the mounting end.

Each terminal may have one or more cuts that produce a mounting end that is narrower in the longitudinal direction than the intermediate portion. The mounting end may have a flat surface extending in a plane perpendicular to the mating direction. Such mounting ends may enable a solder ball having a diameter greater than a width of the flat surface in the longitudinal direction to be attached to the mounting end. For example, solder material may fill a pair of cuts disposed on opposite sides of the mounting end during reflow, occupying a smaller solder area than not having the pair of cuts. Such a configuration can reduce impedance change at the mounting end due to, for example, the addition of solder materials. Signal integrity may be improved through the configuration of the narrower mounting end with the pair of cuts, attaching a larger solder ball to a flat surface of the narrower mounting end of the terminal, and/or the combination thereof. Further, such mounting ends may increase the tolerance of errors in the manufacturing process. For example, while existing surface mount tails may tolerate a maximum of 0.1 mm variation in coplanarity, the mounting ends describe herein may tolerate 0.2 mm variation in coplanarity.

In some embodiments, the mounting ends of the terminals may include portions elongated in a transverse direction perpendicular to the longitudinal direction and the mating direction. These portions may include the flat surfaces configured for solder balls to be attached thereto. Each portion may have a length in the transverse direction. The length may be short enough such that the mounting end is disposed between planes in which opposite sides of the housing of the connector extend. Such mounting ends, which are shorter than mounting ends of known sockets, may improve signal integrity. Signal integrity may also be improved through the use of circular contact pads on a PCB to which the connector is mounted, resulting in smaller solder areas.

In some embodiments, the housing may include an organizer attached at the mounting face. The organizer may be a single component or multiple components. The organizer may have openings disposed corresponding to the channels of the housing such that the mounting ends of the terminals may extend therethrough. The organizer may have first recesses facing toward respective channels of the housing and second recesses facing away from respective channels of the housing. The openings of the organizer may connect respective first recesses and second recesses to each other. The first recesses may be sized and shaped for guiding the mounting ends to extend through the respective openings and restraining movements of the mounting ends during use. The second recesses may be sized and shaped for at least partially holding solder balls attached to respective mounting ends. Such an organizer may reduce the risks of incorrect soldering due to, for example, housing deformation under heat. In some embodiments, the organizer may be formed of a material or materials that can sustain higher temperature than the rest of the housing, which may be molded from a thermoplastic. Such a configuration may reduce the risks of incorrect soldering due to, for example, housing deformation under heat. For example, the organizer may be ceramic.

The organizer may include protrusions configured for securely attaching to the housing of the connector. The protrusions may be disposed in selected locations in the longitudinal direction. Such a secure attachment between the organizer and the housing may ensure accurate soldering.

Techniques described herein may enable the connector to be mounted onto a printed circuit board that have circular contact pads with diameters smaller than the diameters of the solder balls. The configuration of the connector may enable reliable solder joints to form between the mounting ends of the terminals and respective solder pads, without going beyond the area of the solder pads.

Exemplary embodiments of the present disclosure will be described with reference to the drawings. Directions such as a mating direction Z-Z, a longitudinal direction X-X and a transverse direction Y-Y may be indicated in the drawings. The mating direction Z-Z, the longitudinal direction X-X and the transverse direction Y-Y may be perpendicular to each other. The mating direction Z-Z may relate to a height direction of an electrical connector, such as the direction in which an electronic element is inserted into a card edge connector. The longitudinal direction X-X may relate to a length direction of the electrical connector, such as the direction in which a slot of a card edge connector extends. The transverse direction Y-Y may relate to a width direction of the electrical connector.

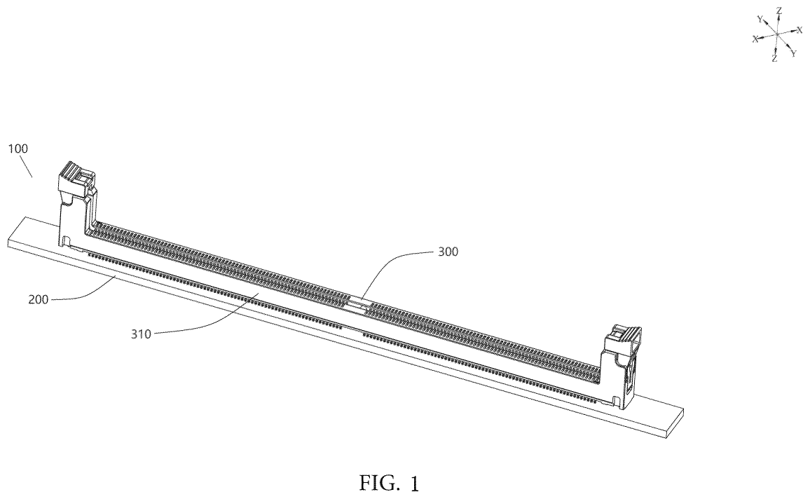

FIG. 1 shows an electronic system 100 according to the present application. The electronic system 100 may comprise a card edge connector 300 and a printed circuit board 200.

In some embodiments, a card edge connector may comprise a housing that may have a slot extending in a longitudinal direction. The slot may be configured for receiving an electronic card such as a memory card. The electronic card may be inserted into the slot in a mating direction perpendicular to the longitudinal direction.

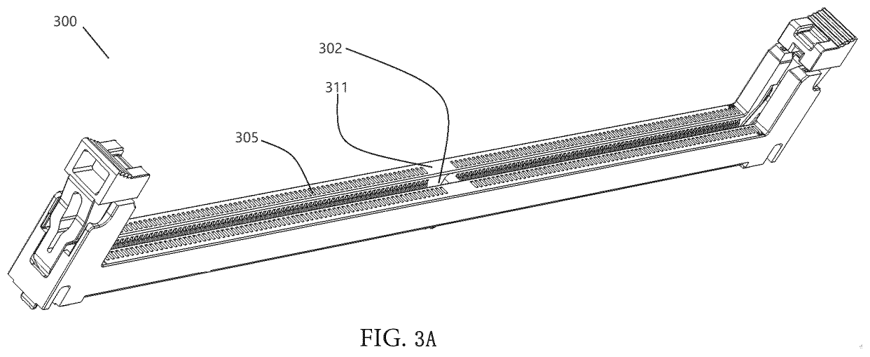

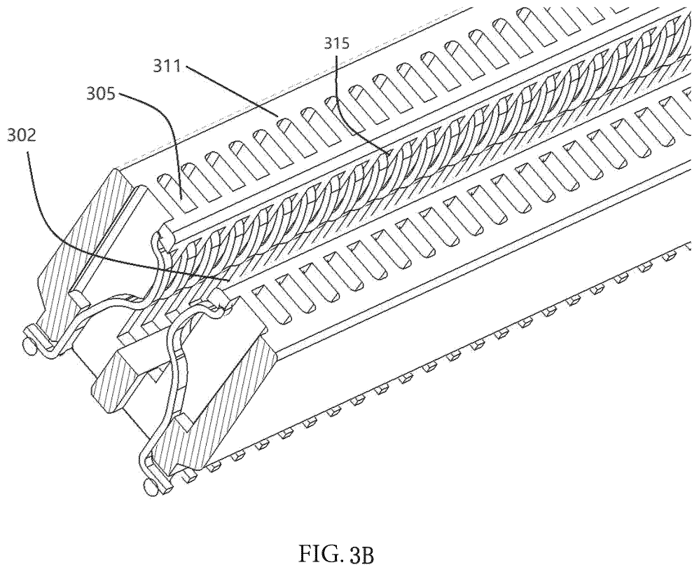

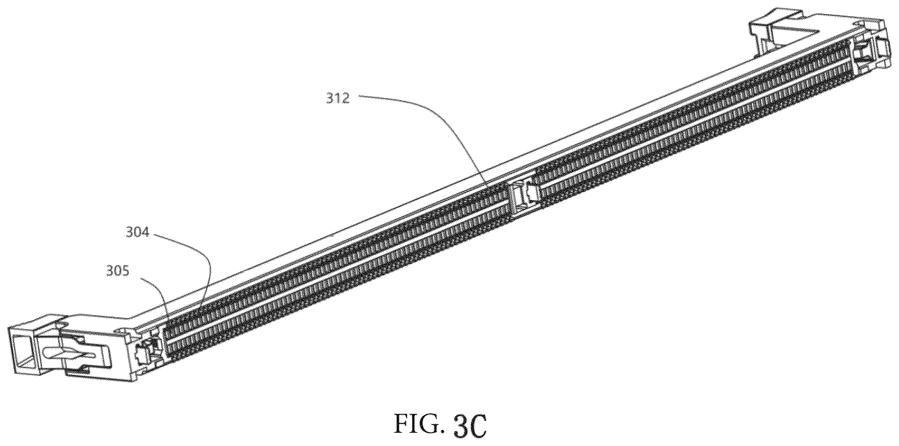

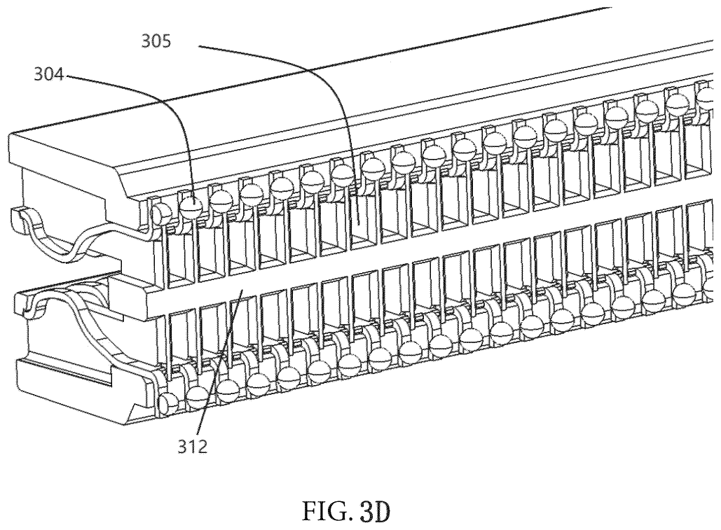

Referring to FIG. 1 to FIG. 5, In some embodiments, the card edge connector 300 may include a housing 310, the housing 310 may comprise a slot 302 extending in a longitudinal direction perpendicular to a mating direction. In some embodiments, as shown in FIG. 3A to FIG. 3D, the housing 310 may comprise a mating face 311 and a mounting face 312 which may be arranged oppositely in the mating direction Z-Z. The slot 302 may be disposed on the mating face 311, as shown in FIG. 3B. Exemplarily, the slot 302 may be recessed from the mating face 311 in the mating direction Z-Z toward the housing 310. The housing 310 may be made of insulating material such as plastic by molding process. The housing 310 may be an integrated element and may also be a substantively lengthwise strip-shaped element. The housing 310 may extend in the longitudinal direction X-X.

In some embodiments, an electrical connector may have terminals held in the channels. Each terminal may have a mating end having a mating contact portion, a mounting end opposite the mating end, and an intermediate portion. The mating contact portion may curve into the slot through the opening of a respective channel. The mounting end may extend out of the mounting face of the housing. The intermediate portion may join the mating end and the mounting end.

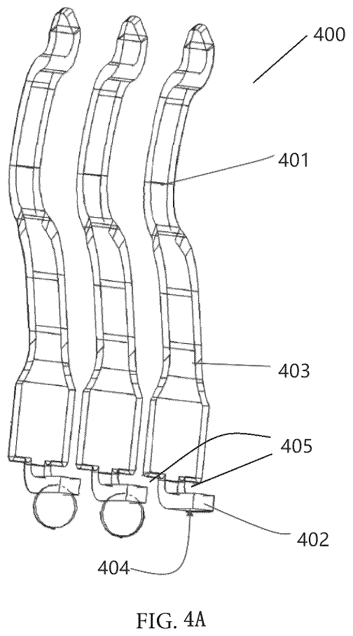

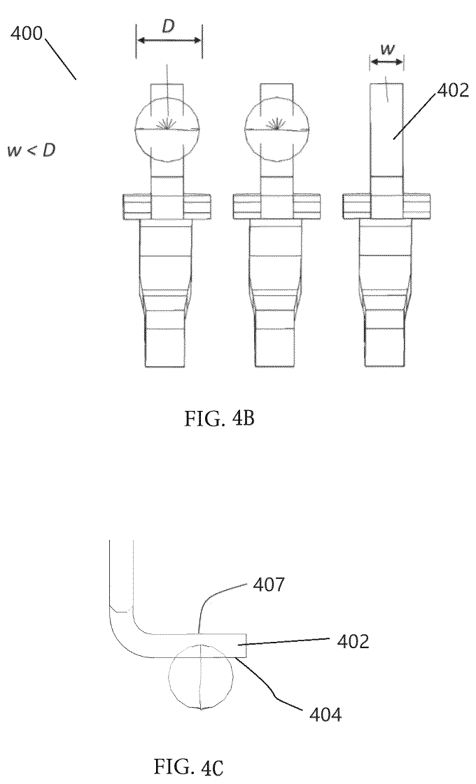

Referring to FIG. 4A, FIG. 4B and FIG. 4C, the housing 310 may comprise a plurality of terminals 400 which may be used for electrical connection with the electronic element inserted in the slot 302. As shown in FIG. 4A, each of the plurality of terminals 400 may comprise a mating end having a mating contact portion 401, a mounting end 402 opposite the mating end, and an intermediate portion 403 joining the mating end and the mounting end 402. In some embodiments, the mating contact portion 401 may curve and project inward to the slot 302, such that the mating contact portion 401 may be electrically connected with the electronic element when the electronic element is inserted to the slot 302. In some embodiments, the mounting end 402 may extend out of the housing 310. In some embodiments, the mounting end 402 of each of the plurality of terminals 400 may project out of the mounting face 312 of the housing 310.

In some embodiments, the intermediate portion 403 may extend between the mating contact end and the mounting end 402, so that the mating end and the mounting end 402 are joined.

Exemplarily, the mounting end 402 may be directly or indirectly soldered with a circular contact pad 202 on the printed circuit board 200 by technology such as BGA (Ball Grid Array). In this way, electronic elements such as electronic cards may be electrically connected with the printed circuit board 200 through the card edge connector 300.

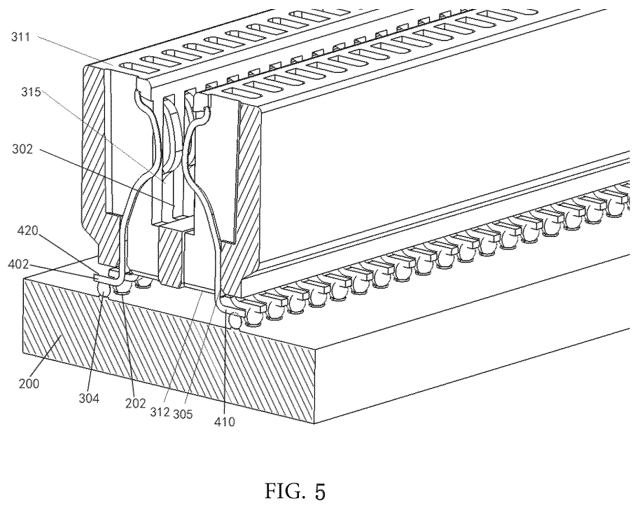

In some embodiments, with reference to FIG. 4A to FIG. 5, the card edge connector 300 may further comprise a plurality of solder balls 304. Each of the plurality of solder balls 304 may be attached to the mounting end 402 of a respective terminal of the plurality of terminals 400.

In some embodiments, each terminal may have a pair of cuts disposed on opposite sides of the mounting end such that the mounting end is narrower than the intermediate portion in the longitudinal direction. The mounting end may have a flat surface extending in a plane perpendicular to the mating direction. Such mounting ends may enable a solder ball having a diameter greater than a width of the flat surface in the longitudinal direction to be attached to the mounting end. For example, solder material may fill the pair of cuts during reflow. Such a configuration can reduce impedance change at the mounting end due to, for example, the addition of solder materials. Signal integrity may be improved through the configuration of narrower mounting end with the pair of cuts, attaching a larger solder ball to a flat surface of the narrower mounting end of the terminal, and/or the combination thereof. Further, such mounting ends may increase the tolerance of errors in the manufacturing process. For example, while existing surface mount tails may tolerate a maximum of 0.1 mm variation in coplanarity, the mounting ends describe herein may tolerate 0.2 mm variation in coplanarity.

Referring to FIG. 4A and FIG. 4B, in some embodiments, each terminal of the plurality of terminals 400 may comprise a pair of cuts 405 disposed on opposite sides of the respective mounting end 402. In this way, the mounting end 402 of each of the plurality of terminals is narrower than the respective intermediate portion 403 in the longitudinal direction and is disposed such that the respective intermediate portion 403 extends in the longitudinal direction beyond the opposite sides of the mounting end 402.

In some embodiments, the mounting end 402 of each of the plurality of terminals 400 may comprise a flat surface 404. Each of the plurality of solder balls 304 may be attached to the flat surface 404 of the mounting end 402 of a respective terminal of the plurality of terminals 400. In some embodiments, the flat surface 404 of the mounting end 402 of each of the plurality of terminals 400 may have a width w in the longitudinal direction less than a diameter D of the respective solder ball 304 attached to the mounting end 402.

In some embodiments, the mounting end 402 of each of the plurality of terminals 400 may be disposed in a central portion of the respective intermediate portion 403.

In some embodiments, the mounting ends of the terminals may include portions extending in a transverse direction perpendicular to the longitudinal direction and the mating direction. These portions may include the flat surfaces configured for attaching the solder balls thereto. Each portion may have a length in the transverse direction. The length may be short enough such that the mounting end is disposed between planes in which opposite sides of the housing of the connector. Such mounting ends, which are shorter than mounting ends of known sockets, may improve signal integrity. Signal integrity may also be improved through the use of circular contact pads on a PCB to which the connector is mounted, resulting in smaller solder areas.

Referring to FIG. 5, in some embodiments, the mounting end 402 of each of the plurality of terminals 400 comprises a portion 407 extending in a transverse direction perpendicular to the mating direction and the longitudinal direction. In some embodiments, as shown in FIG. 4C, the portion 407 may comprise a flat surface 404 attached with the solder ball 304. In some embodiments, the portion 407 extending in the transverse direction of the mounting end 402 of each terminal may be sized such that the portion 407 is positioned between planes in which opposite sides of the housing 310, which may improve the integrity of signals.

In some embodiments, the housing may have a channel which extends from the mating face to the mounting face. The channel may have an opening leading to the slot.

Referring to FIG. 3A to 3D and FIG. 5, in some embodiments, a plurality of openings 315 are arranged respectively on the two side surfaces of the slot 302 extending in the longitudinal direction. The housing 310 may further comprise a plurality of channels 305. Each channel may extend from the mounting face 312 of the housing 310 through the housing 310 and be in communication with the slot 302 via a respective opening of the plurality of openings 315.

As shown in FIG. 5, the plurality of terminals 400 may comprise a plurality of first terminals 410 arranged in a first row and a plurality of second terminals 420 arranged in a second row parallel to the first row. The first terminal 410 and the second terminal 420 may be configured similar to the terminals 400 described above. As illustrated, the second terminal 420 may comprise a mating end having a mating contact portion curving into the slot and toward the mating contact portion of a respective terminal of the first plurality of terminals, and a mounting end extending out of the housing and away from the mounting end of a respective first terminal of the first plurality of terminals. As illustrated, the plurality of first terminals 410 and the plurality of second terminals 420 are disposed in the longitudinal direction of the housing 310, each of the first terminal 410 and the second terminal 420 is shaped as an elongated rib-shaped plate.

In the embodiments as shown in FIG. 5, the mounting end of each of the plurality of second terminals 420 comprises a portion 413 extending in the transverse direction, and the portion 413 is sized in the transverse direction such that the portion 413 is positioned between planes in which the opposite sides of the housing 310 extend.

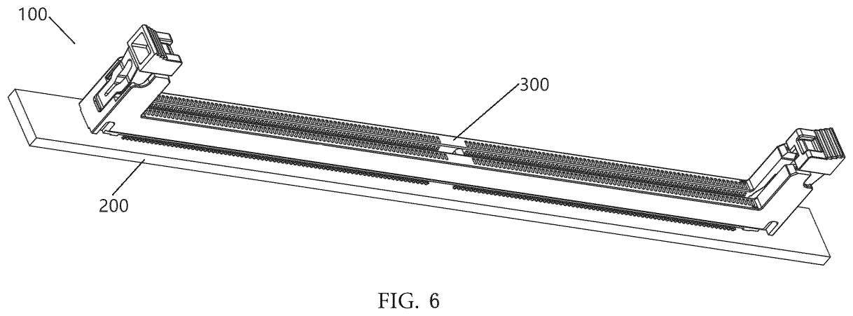

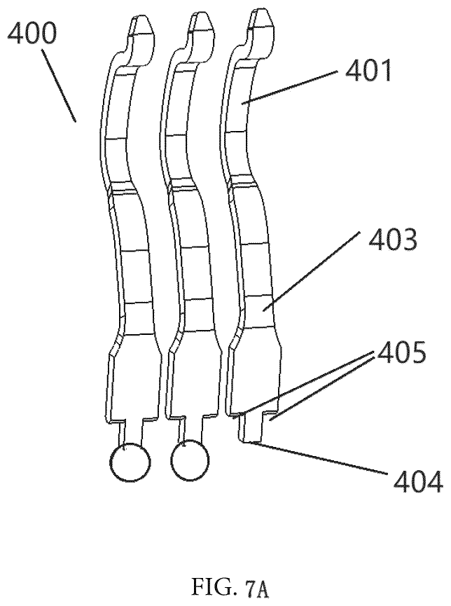

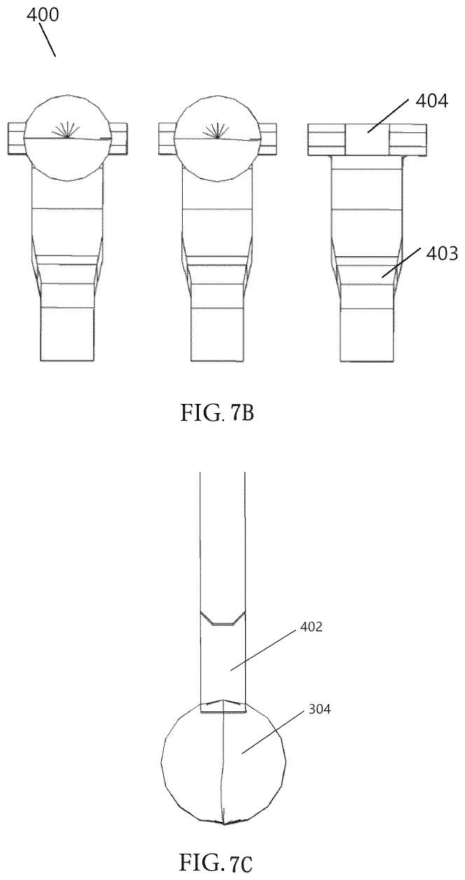

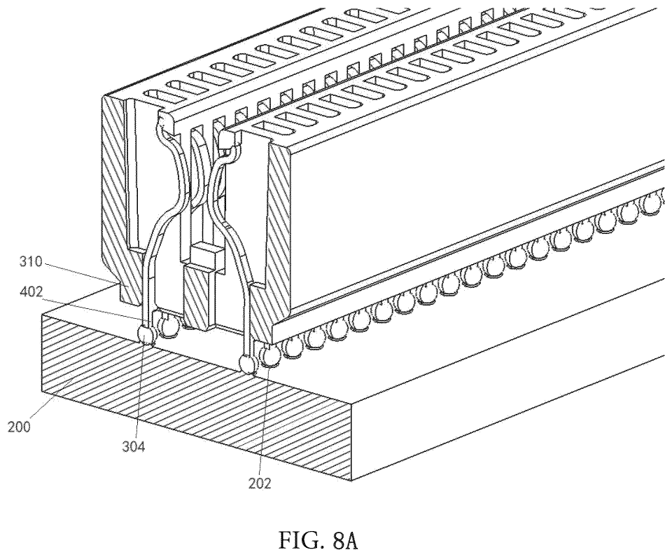

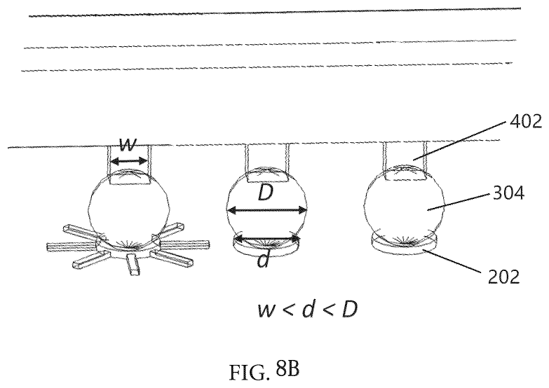

FIG. 6 shows an electronic system according to another embodiment of the present application. As illustrated, the electronic system of FIG. 6 may include a card edge connector 300. The card edge connector 300 of the electronic system of FIG. 6 may have terminals as shown in FIGS. 7A-8A. As illustrated, different from the mounting end 402 shown in FIG. 5, the mounting end 402 shown in FIGS. 7A-8A may extend in the mating direction. As shown in FIG. 7A and FIG. 8A the flat surface 404 of the mounting end 402 extends in a plane perpendicular to the mating direction.

As shown in FIG. 8A and FIG. 8B, in some embodiments, the terminal 400 of the card edge connector 300 may be electrically coupled to a plurality of circular contact pads 202 of the printed circuit board 200 via the solder balls 304. In some embodiments, a diameter D of the solder ball 304 may be arranged to be greater than a diameter d of a respective circular contact pad 202. In some embodiments, the diameter d of the circular contact pad 202 may be greater than the width w of the mounting end 402 of a respective terminal in the longitudinal direction.

As illustrated, the card edge connector 300 can be mounted to the printed circuit board 200 with the circular contact pad 202, while the diameter d of the circular contact pad 202 is less than the diameter D of the solder ball 304 and greater than the width w of the mounting end 402 of the terminal in the longitudinal direction. The electronic system comprising the card edge connector of this type can form reliable solder joints between the mounting end of the terminal and the respective circular contact pad, and the solder joints would not go beyond the area of the circular contact pad, such that the integrity of signal can be improved.

Referring to FIG. 8B again, In some embodiments, the printed circuit board 200 may comprise one or more conductive traces extending from a respective circular contact pad of the plurality of circular contact pads 202, the conductive trace is electrically connected with a terminal assembly 400 via the circular contact pad 202 and the solder ball 304, which may provide more flexibility for the electronic assembly. The conductive trace may be electrically connected with the circular contact pad 202 in any angle, such that a uniform and stable connection impedance can be ensured between the plurality of conductive traces connected to the different circular contact pads 202.

In some embodiments, the housing may include an organizer attached at the mounting face. The organizer may be a single component or multiple components.

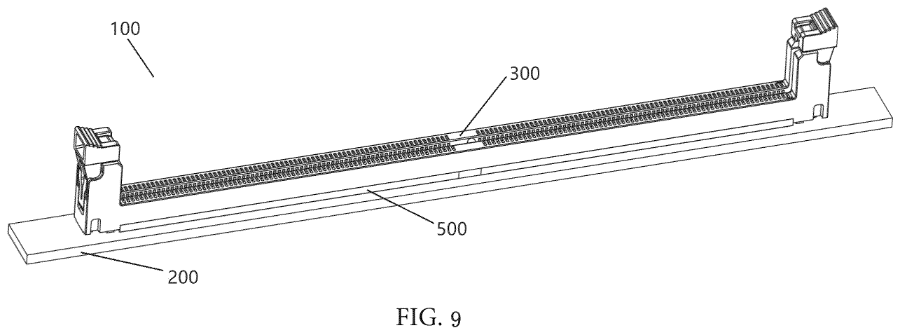

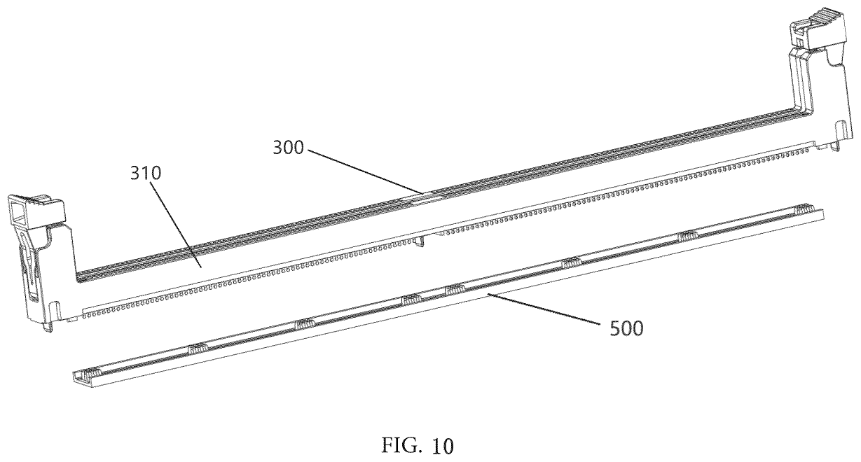

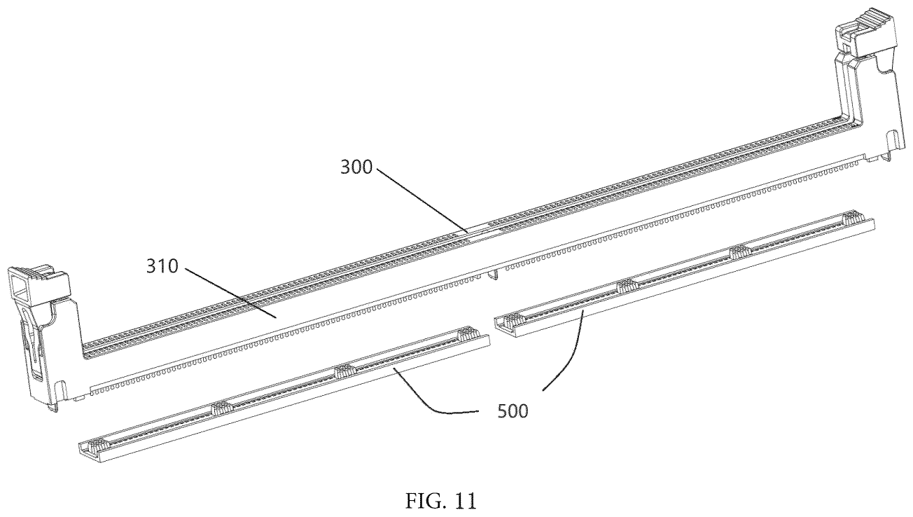

Referring to FIG. 9 which shows an electronic system according to another embodiment of the present application. As illustrated, the electronic system of FIG. 6 may include a card edge connector 300. The card edge connector as shown in FIG. 9 may comprise an organizer 500. In some embodiments, the organizer 500 may be a single component, as shown in FIG. 10. In some embodiments, the organizer 500 may be multiple components, as shown in FIG. 11. In the embodiment as shown in FIG. 11, the organizer 500 refers to two components. In some embodiments, the organizer 500 is attached to the housing 310.

In some embodiments, the organizer may have openings disposed corresponding to the channels of the housing such that the mounting ends of the terminals may extend therethrough. The organizer may have first recesses facing toward respective channels of the housing and second recesses facing away from respective channels of the housing. The openings of the organizer may connect respective first recesses and second recesses to each other.

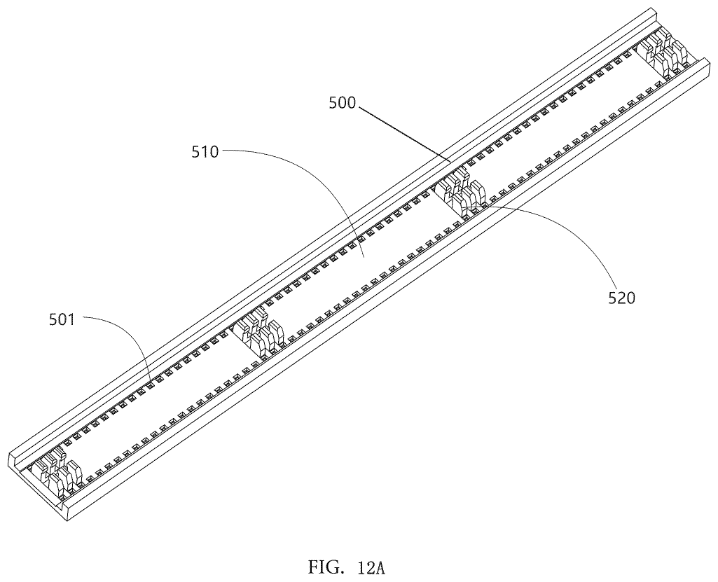

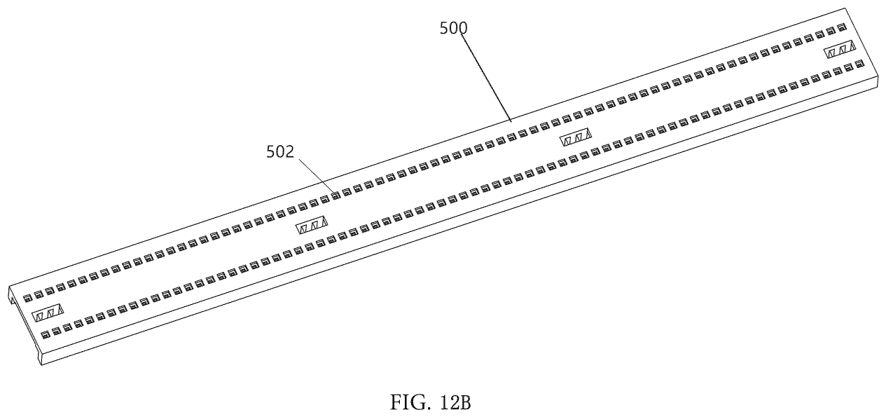

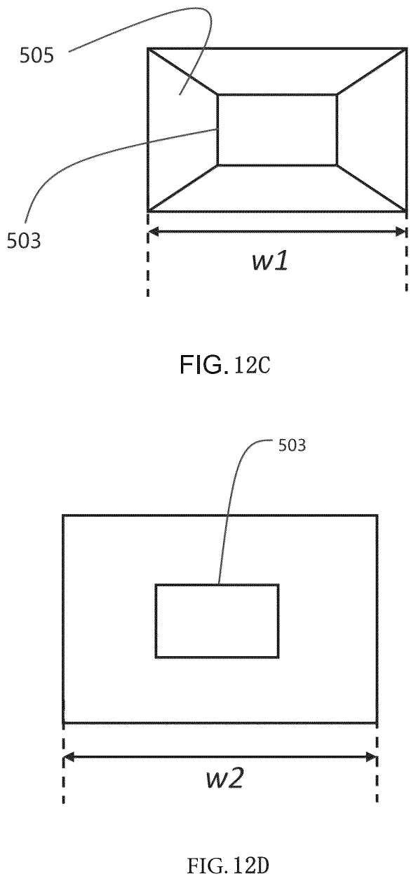

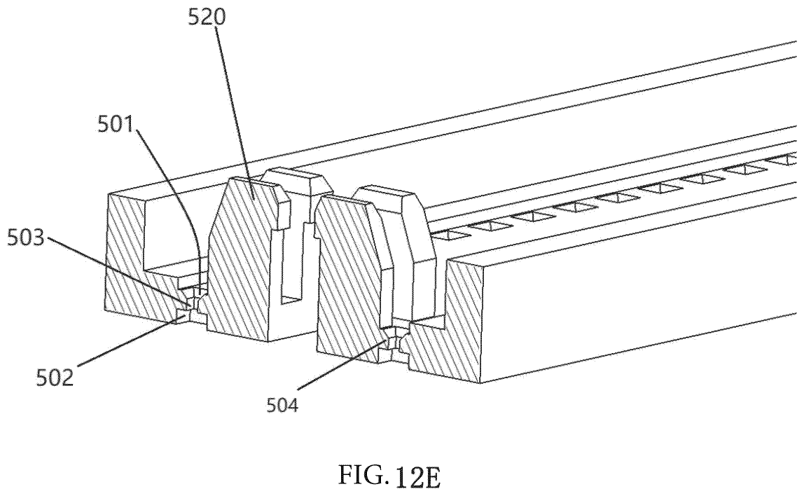

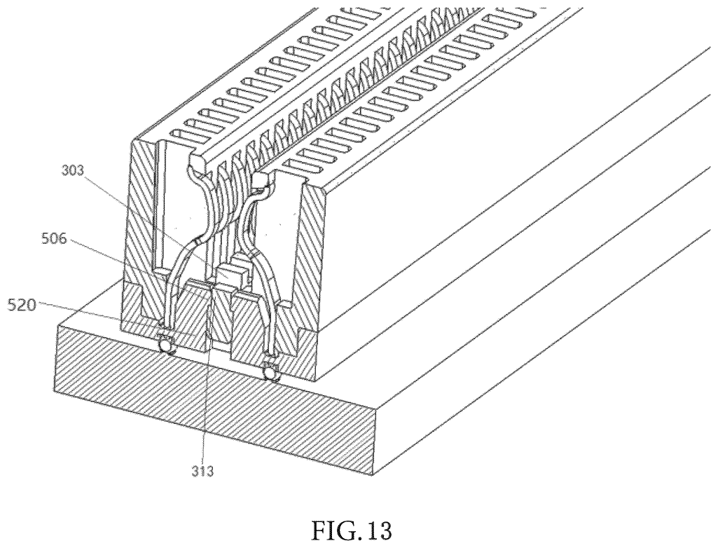

Referring to FIG. 12A to FIG. 12E and FIG. 13, in some embodiments, the organizer 500 may comprise a plurality of first recesses 501, a plurality of second recesses 502, and openings 503 connecting respective first recesses 501 and second recesses 502 to each other. In some embodiments, the organizer comprises a first surface attached with the housing 310 and a second surface opposite to the first surface. The first recess 501 is disposed on the first surface facing toward the housing 310 such that the first recess 501 is recessed toward the second surface from the first surface. In some embodiments, the second recess 502 faces away the housing 310, such that the second recess 502 is recessed toward the first surface from the second surface of the organizer 500.

In some embodiments, the first recesses may be sized and shaped for guiding the mounting ends to extend through the respective openings and restraining movements of the mounting ends during use. The second recesses may be sized and shaped for at least partially holding solder balls attached to respective mounting ends. Such organizer may reduce the risks of incorrect soldering due to, for example, housing deformation under heat. In some embodiments, the organizer may be formed of a material or materials that can sustain higher temperature than the rest of the housing, which may be molded from a thermoplastic. Such configuration may reduce the risk of incorrect soldering due to, for example, housing deformation under heat. For example, the organizer may be ceramic.

Referring to FIG. 13, in some embodiments, the mounting end 402 of each of the plurality of terminals 400 may extend through the respective opening 503 from the respective first recess 501 to the respective second recess 502.

In some embodiments, the mounting end 402 of each of the plurality of terminals 400 may comprise a flat surface 404. The flat surface 404 may extend in a plane perpendicular to the mating direction and may be disposed within the respective second recess 502.

In some embodiments, the flat surface 404 of the mounting end 402 of each of the plurality of terminals 400 is attached with the solder ball 304, and the plurality of solder balls 304 may be electrically coupled to the plurality of terminals 400.

In some embodiments, each of the plurality of solder balls 304 may be at least partially disposed in a respective second recess of the plurality of second recesses of the organizer 500.

As shown in FIG. 12C and FIG. 12D, in some embodiments, each of the plurality of first recesses 501 may have a first width w1 in the longitudinal direction. Each of the plurality of second recesses 502 may have a second width w2 in the longitudinal direction. In the optional embodiments, the second width w2 may be greater than the first width w1. In such way, the first recess 501 may restrain movements of the mounting end 402 during use, the second recess 502 may be at least partially holding the solder ball attached to the respective mounting end 402. The card edge connector with the organizer 500 may reduce the risk of incorrect soldering due to, for example, housing 310 deformation under heat.

In some embodiments, the organizer may include protrusions configured for securely attaching to the housing of the connector. The protrusions may be disposed in selected locations in the longitudinal direction. Such secure attachment between the organizer and the housing may ensure accurate soldering.

With reference to FIG. 12E and FIG. 13, in some embodiments, the organizer 500 may comprise a plurality of projections 504. In some embodiments, a respective opening of the plurality of openings 503 is surrounded by respective projections of the plurality of projections 504. In some embodiments, each of the plurality of projections 504 may comprise slanted surfaces bounding a respective first recess 501.

With reference to FIG. 12A and FIG. 12B, in some embodiments, the organizer 500 may comprise a base portion 510 extending in another plane perpendicular to the mating direction and a plurality of protrusions 520 extending perpendicular to the base portion 510 and toward the housing 310. In some embodiments, each of the plurality of protrusions 520 may comprise a projection 506 disposed in a matching recess 313 of the housing 310, as shown in FIG. 13. The manner in which the housing 310 is connected with the organizer 500 may not be limited to the embodiments as indicated in figures, as long as the housing 310 can be firmly attached with the organizer 500.

In some embodiments, the housing 310 may comprise separators 303 disposed between adjacent matching recesses 313 so as to restrain movements of the plurality of protrusions 520 in the longitudinal direction and/or transverse direction.

In some embodiments, the card edge connector is mounted onto a printed circuit board with circular contact pads with diameters less than the diameters of the solder balls. The configuration of the card edge connector can form reliable solder joints between the mounting ends of the terminals and respective circular contact pads, without going beyond the area of the contact pads.

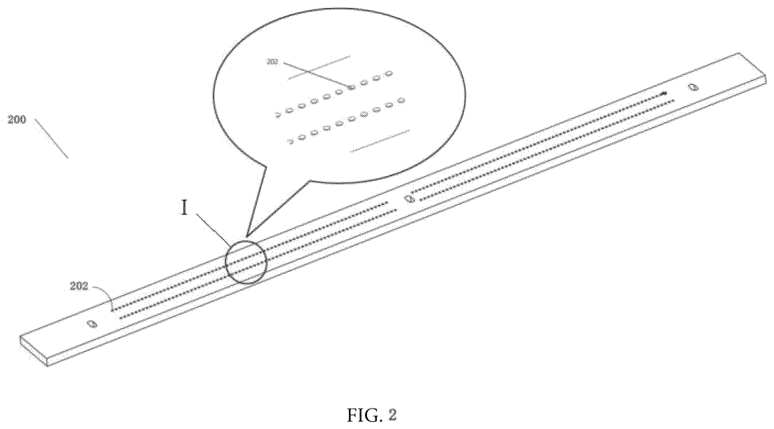

Referring to FIG. 1, FIG. 6, and FIG. 10, in some embodiments, the electronic system 100 may comprise a printed circuit board 200 and a card edge connector 300. In some embodiments, the printed circuit board 200 may comprise a surface with a plurality of circular contact pads 202, as shown in FIG. 2. FIG. 2 also shows the detailed view of the circular part I of the circular contact pads 202. In some embodiments, the plurality of circular contact pads 202 may be aligned in the longitudinal direction.

In some embodiments, the card edge connector may be the card edge connector 300 described with reference to FIG. 8A and FIG. 8B. The card edge connector 300 may comprise the housing 310, a plurality of terminals 400, and a plurality of solder balls 304. The plurality of terminals 400 may be held by the housing 310. Each of the plurality of terminals 400 may comprise a mating end having a mating contact portion 401 curving into the slot 302 and a mounting end 402 extending out of the housing 310. Each of the plurality of solder balls 304 may be attached to the mounting end 402 of a respective terminal of the plurality of terminals 400.

In some embodiments, each of plurality of solder balls 304 electrically may couple the plurality of terminals 400 of the card edge connector to a respective one of the plurality of circular contact pads 202 of the printed circuit board 200. In the optional embodiments, a diameter D of the solder ball 304 is greater than a diameter d of a respective circular contact pad 202, and the diameter d of the respective circular contact pad is greater than the width w of the mounting end 402 of a respective terminal in the longitudinal direction.

In the optional embodiments, the mounting end 402 of each of the plurality of terminals 400 may comprise a flat surface 404 attached with a respective solder ball of the plurality of solder balls 304.

In the optional embodiments, each of the plurality of terminals 400 may comprise a pair of cuts 405 which may be disposed on opposite sides of a respective mounting end 402.

In some embodiments, as shown in FIG. 8B, the printed circuit board 200 may comprise a trace 610 extending from the plurality of circular contact pads 202. In some embodiments, the trace 610 may extend in a direction extending in a non-right angle to the longitudinal direction, as illustrated in FIG. 8B.

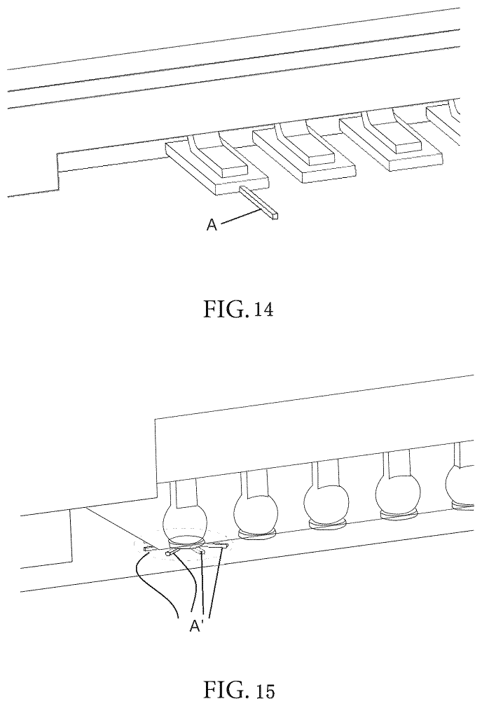

FIG. 14 is a schematic illustration of pads and a routing direction for a pad of a conventional connector with surface mount terminals. As illustrated, a conventional surface mount terminal requires a square contact pad which should have a larger surface area than the conventional surface mount terminal. Further, a trace connecting the square contact pad can extend in a limited direction so as to meet layout design requirements that prevent short circuits.

FIG. 15 is a schematic illustration of pads and routing directions for a pad of a connector, according to some embodiments of the present application. As illustrated, the terminals can be mounted to contact pads that have smaller surface areas than the solder balls attached to the terminals. The contact pads can be circular. Traces connecting the contact pads can extend in various directions, providing flexible routing directions.

Although details of specific configurations of conductive elements and housings are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art.

For example, techniques as described herein may be embodied in card edge connectors or connectors configured only for high-speed signals.

As another example, high-speed and low-speed signal terminals may be configured the same, with signal terminals in the same row having the same shape. The high-speed and low-speed signal terminals nonetheless may be differentiated based on the ground structures and insulative portions around them. Alternatively, some or all of the high-speed signal terminals may be configured differently from low-speed signal terminals, even within the same row. The edge-to-edge spacing may be closer for high-speed signal terminals, for example.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. An electrical connector comprising:
a housing comprising a slot;
a plurality of terminals held by the housing, each of the plurality of terminals comprising a mating end having a mating contact portion curving into the slot, a mounting end opposite the mating end, and an intermediate portion joining the mating end and the mounting end; and
a plurality of solder balls, each of the plurality of solder balls attached to the mounting end of a respective terminal of the plurality of terminals, wherein:
the mounting end of each of the plurality of terminals is narrower than the respective intermediate portion and disposed such that the respective intermediate portion extends beyond opposite sides of the mounting end;
the mounting end of each of the plurality of terminals comprises a flat surface;
each of the plurality of solder balls is attached to the flat surface of the mounting end of a respective terminal of the plurality of terminals; and
the flat surface of the mounting end of each of the plurality of terminals is narrower than the respective solder ball attached thereto.

2. The electrical connector of claim 1, wherein:
the mounting end of each of the plurality of terminals is disposed in a central portion of the respective intermediate portion; and
each of the plurality of terminals comprises a pair of cuts disposed on the opposite sides of the respective mounting end.

3. The electrical connector of claim 1, wherein:
the slot of the housing is configured for receiving a DDR card.

4. The electrical connector of claim 1, wherein:
the mounting end of each of the plurality of terminals comprises a portion extending perpendicular to a mating direction; and
the portion comprises the flat surface attached with the solder ball.

5. The electrical connector of claim 4, wherein:
the slot of the housing extends in a longitudinal direction perpendicular to the mating direction;
the portion of the mounting end of each of the plurality of terminals has a length in a transverse direction perpendicular to the mating direction and the longitudinal direction; and
the length of the portion of the mounting end of each of the plurality of terminals is sized such that the portion is positioned between planes in which opposite sides of the housing extend.

6. The electrical connector of claim 5, wherein:
the plurality of terminals are a plurality of first terminals arranged in a first row;
the electrical connector comprises a plurality of second terminals arranged in a second row parallel to the first row; and
each of the plurality of second terminals comprises a mating end having a mating contact portion curving into the slot and toward the mating contact portion of a respective first terminal of the plurality of first terminals, and a mounting end extending out of the housing and away from the mounting end of the respective first terminal of the plurality of first terminals.

7. The electrical connector of claim 6, wherein:
the mounting end of each of the plurality of second terminals comprises a portion extending in the transverse direction;
the portion of the mounting end of each of the plurality of second terminals has a length in the transverse direction; and
the length of the portion of the mounting end of each of the plurality of second terminals is sized such that the portion is positioned between the planes in which the opposite sides of the housing extend.

8. An electrical connector comprising:
a housing comprising a slot;
a plurality of terminals held by the housing, each of the plurality of terminals comprising: a mating end having a mating contact portion curving into the slot, a mounting end opposite the maing end, and an intermediate portion joining the mating end and the mounting end, the intermediate portion being wider than the mounting end; and
an organizer attached to the housing, the organizer comprising a plurality of first recesses facing toward the housing, a plurality of second recesses facing away from the housing, and a plurality of openings connecting respective first recesses and second recesses to each other, wherein:
the mounting end of each of the plurality of terminals extends from a respective first recess through a respective opening to a respective second recess; and
the mounting end of each of the plurality of terminals comprises a flat surface extending in a plane perpendicular to a mating direction and disposed inside a respective second recess.

9. The electrical connector of claim 8, wherein:
the organizer comprises a plurality of projections; and
a respective opening of the plurality of openings is surrounded by respective projections of the plurality of projections.

10. The electrical connector of claim 9, wherein:
each of the plurality of projections comprises slanted surfaces bounding a respective first recess.

11. The electrical connector of claim 8, wherein:
the slot of the housing extends in a longitudinal direction;
each of the plurality of first recesses has a first width the longitudinal direction;
each of the plurality of second recesses has a second width in the longitudinal direction; and
the second width is greater than the first width.

12. The electrical connector of claim 8, wherein:
the organizer comprises a base portion extending in another plane perpendicular to the mating direction and a plurality of protrusions extending perpendicular to the base portion and toward the housing; and
each of the plurality of protrusions comprises a projection disposed in a matching recess of the housing.

13. The electrical connector of claim 12, wherein:
the housing comprises separators disposed between adjacent matching recesses so as to restrain movements of the plurality of protrusions in the longitudinal direction and/or a transverse direction perpendicular to both the longitudinal direction and the mating direction.

14. The electrical connector of claim 8, wherein:
the organizer comprises ceramic.

15. The electrical connector of claim 10, further comprising:
a plurality of solder balls attached to the flat surfaces of the mounting ends of respective terminals of the plurality of terminals,
wherein each of the plurality of solder balls is at least partially disposed in a respective second recess of the plurality of second recesses of the organizer.

16. The electrical connector of claim 15, wherein:
the slot of the housing extends in a longitudinal direction; and
the flat surface of the mounting end of each of the plurality of terminals is narrower than a respective solder ball of the plurality of solder balls in the longitudinal direction.

17. An electronic system comprising:
a printed circuit board comprising a surface having a plurality of contact pads; and
an electrical connector comprising:
a housing comprising a slot, and
a plurality of terminals held by the housing in a row in a longitudinal direction, each of the plurality of terminals comprising a mating end having a mating contact portion curving into the slot and a mounting end opposite the mating end; and
a plurality of solder balls electrically coupling the plurality of terminals of the electrical connector to the plurality of contact pads of the printed circuit board, wherein:
the plurality of solder balls are wider than respective contact pads in the longitudinal direction; and
the mounting ends of the plurality of terminals are narrower respective contact pads in the longitudinal direction.

18. The electronic system of claim 17, wherein:
the printed circuit board comprises a trace extending from a contact pad of the plurality of contact pads; and
the trace is elongated in a direction extending in a non-right angle to the longitudinal direction.

19. The electronic system of claim 18, wherein:
the plurality of contact pads are circular contact pads.

20. The electronic system of claim 17, wherein:
the mounting end of each of the plurality of terminals comprises a flat surface attached with a respective solder ball of the plurality of solder balls; and
each of the plurality of terminals comprises a pair of cuts disposed on opposite sides of a respective mounting end.
